(19) United States
(12) Patent Application Publication
(10) Pub. No.: US 2024/0051757 A1
(43) Pub. Date: Feb. 15, 2024

(54) VARIABLE FRICTION CHUTE

(71) Applicant: Marble, Inc., Cambridge, MA (US)

(72) Inventor: Tyler Randolph, Edgefield, SC (US)

(21) Appl. No.: 18/449,566

(22) Filed: Aug. 14, 2023

Related U.S. Application Data
(60) Provisional application No. 63/397,513, filed on Aug. 12, 2022.

(51) Int. Cl. B65G 11/16; B65G 11/20; B65G 43/08

(52) U.S. Cl. CPC B65G 11/163; B65G 11/203; B65G 43/08; B65G 2203/025; B65G 2203/0258; B65G 2201/0202

(57) ABSTRACT

A product distribution system including a chute and a controller. The chute includes a variable friction angled surface configured to receive a product and/or slidably transport the product along the angled surface. The controller is operatively coupled with the chute. The controller is configured to vary an amount of friction at the angled surface based on information about the product.

### RELATED APPLICATIONS

This application claims the benefit of U.S. Provisional Patent Application No. 63/397,513, filed Aug. 12, 2022, the entire contents of which are incorporated herein by reference.

### TECHNICAL FIELD

Illustrative embodiments of the invention generally relate to product distribution and packaging, and more particularly, various embodiments of the invention relate to moving products during food processing, such as vacuum-sealed meat.

### BACKGROUND

Meat processing plants typically process different meat products. These meat products are sorted into groups, distributed in a packaging facility for packing and boxing, and packaged for transport to stores, restaurants, or end users.

### SUMMARY

In accordance with one embodiment of the invention, a product distribution system includes a chute and a controller. The chute includes an angled, variable friction surface configured to receive a product and/or slidably transport the product. The controller is operatively coupled with the chute. The controller selects or varies an amount of friction for the angled surface as a function of the product or some information about the product.

The variable friction angled surface may include a plurality of high friction portions and a plurality of low friction portions. The controller adjusts the relative positions of the high friction portions and the low friction portions to vary the amount of friction presented by the angled surface to the product received by the chute. The controller may vary the friction based on, or as a function of, the product (e.g., based on characteristics of the product).

In some embodiments, the controller controls a height in response to sensor data. The controller may raise and lower the height of the plurality of high friction portions relative to the plurality of low friction portions in response to the sensor data. Sensor data (e.g., a signal comprising information derived from a sensor) may correspond to the presence of a meat product at certain locations relative to the chute, or to the speed of movement of a meat product descending along a top surface of the chute, for example.

The plurality of low friction portions may include a top surface comprised of stainless steel or UEMW (ultra high molecular weight polyethylene), for example. The plurality of high friction portions may include a top surface comprised of silicone rubber, for example.

The product distribution system may include a landing pad disposed near a lower end of the chute structured to retain a meat product. The product distribution system may also include one or more actuators structured to raise and lower at least one of the plurality of low friction portions and the plurality of high friction portions relative to the other.

The controller may operate the actuators in response to sensor data, wherein the sensor data may include speed data. The controller may operate the actuators to adjust the height of the at least one of the plurality of low friction portions or the plurality of high friction portions in response to a speed of the product reaching or exceeding a speed threshold, for example. The speed threshold may be greater than zero.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF DRAWINGS

Those skilled in the art should more fully appreciate advantages of various embodiments of the invention from the following “Description of Illustrative Embodiments,” discussed with reference to the drawings summarized immediately below:

FIGS. 1A-1B illustrate an exemplary meat conveyor system including exemplary smart chutes;

FIG. 2 is a perspective view illustrating a top surface of an exemplary smart chute;

FIG. 3 is a perspective view illustrating a bottom portion of an exemplary smart chute;

FIG. 4A is a cross sectional side view illustrating a high friction slat of an exemplary smart chute;

FIG. 4B is an enlarged cross sectional side view illustrating a high friction slat of an exemplary smart chute;

FIG. 5A is a cross sectional side view illustrating a low friction slat of an exemplary smart chute;

FIG. 5B is an enlarged cross sectional side view illustrating a low friction slat of an exemplary smart chute;

FIGS. 6A and 6B are cross sectional views illustrating a high friction mode and a low friction mode, respectively, of exemplary smart chutes; and

FIG. 7 is an exploded top perspective view of an exemplary smart chute having an optional roll prevention feature.

### DETAILED DESCRIPTION

In illustrative embodiments, a variable friction chute (also referred to herein as a “smart chute”) controls the descent of a product (e.g., food products, including meat products) placed on an angled surface of the chute, the angled surface having a friction adjustable/variable friction surface. Among other implementations, the friction adjustable surface is made of a number of high friction slats and low friction slats which may be raised and/or lowered relative to each other to vary the amount of friction presented by the angled surface to the products placed thereon. Raising/lowering the high friction slats and low friction slats relative to each other may cause one or the other to have more or less contact with the outer surface of the products placed thereon (e.g., meat products, in the case of a meat processing facility). The smart chute controls the rate of descent of the meat products by controlling slat contact with the meat products, which affects the overall amount of friction presented by the angled surface of the chute. For example, if the high friction slats are raised relative to the low friction slats, the meat product will experience a higher overall level of friction on the angled surface of the chute, which will tend to slow down or stop the product from sliding down the angled surface. Preferably, the amount of friction is a function of some aspect or characteristic of the meat product to be transferred by the chute. Details of illustrative embodiments are discussed below.

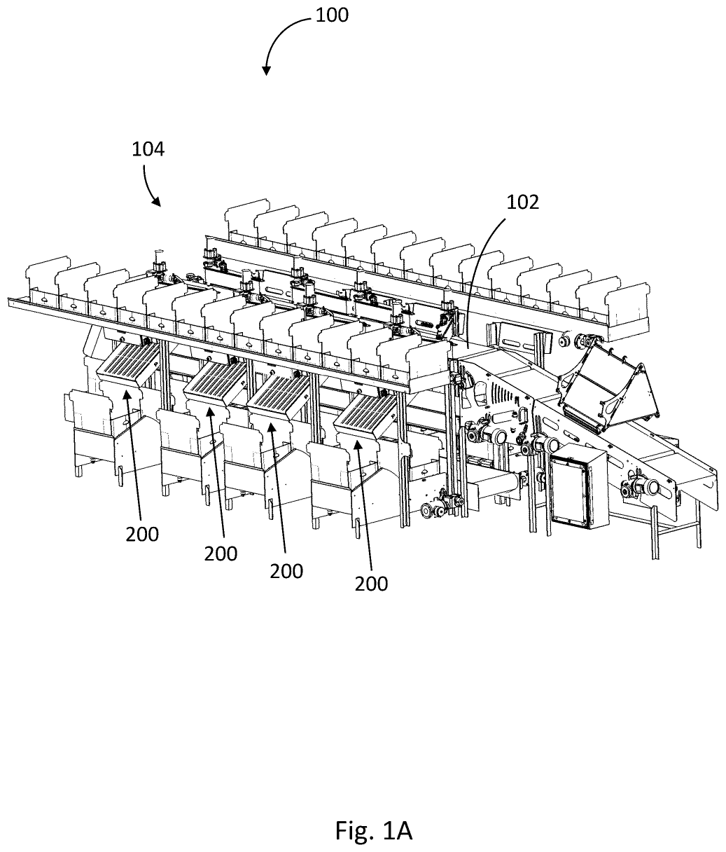

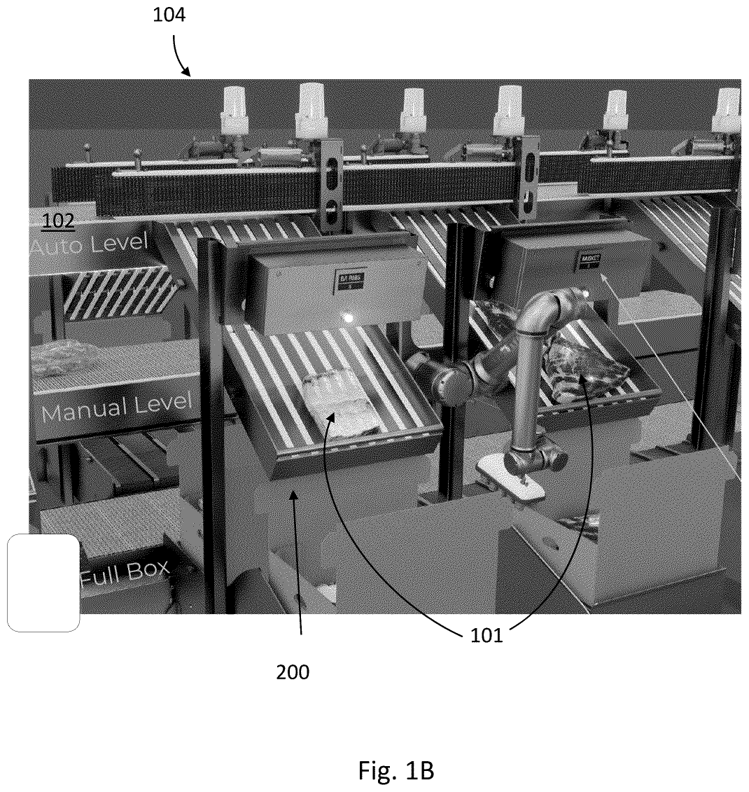

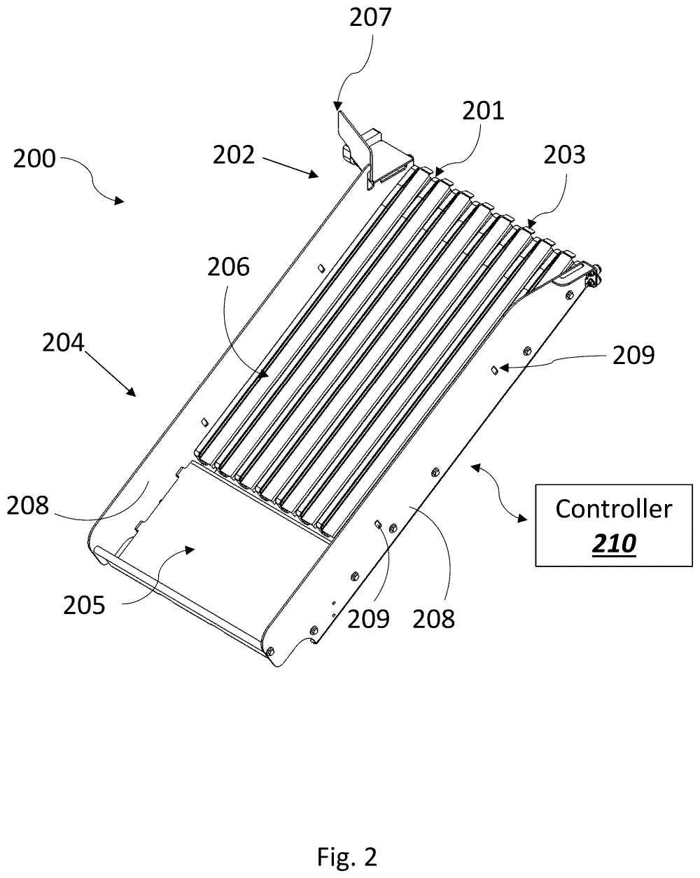

FIGS. 1A and 1B, schematically show a variable friction chute 200 (a “smart chute”) being used as part of a meat conveyor system 100 that may be configured in accordance with illustrative embodiments. As shown, the system 100 has meat products 101 moving along an upper conveyor 102. Powered diverters 104 along the upper conveyor 102 are structured to direct the meat products 101 to one of the smart chutes 200. Mounting brackets attach the smart chutes 200 to the top tier of the three-level conveyor system with one of the powered diverters 104. The smart chutes 200 are structured to move the meat product 101 from the upper conveyor 102 to a landing pad 205 (see FIG. 2) of the smart chute 200 positioned just above the box into which the meat product will be packed. At the smart chute stage, the meat may be vacuum packed in a plastic or other containing apparatus, although various embodiments apply to meat that is not packaged in this manner (e.g., packaged in some non-vacuum packed packaging), or not packaged at all.

Some meat products have a round shape that makes them susceptible to rolling. There is concern that a round product, swept off the conveyor by the powered diverter, might begin to roll down the smart chute. For this reason, the system may include an extended side bracket of the smart chute and extend a rod across the smart chute several inches above the body of the chute. A section of belting or a weighted flap may be hung from the rod. This will apply pressure from above to meat products in order to prevent rolling. The weight of the belt or flap will give some pressure to keep the product on the chute and limit rolling of round products.

The meat conveyor system 100 is structured to allow for sorting and packaging meat products 101 of varying sizes and shapes. The illustrated embodiment may sort and package various sizes and shapes throughout a single production shift where space in a facility is limited. If a single type of meat product was consistently or exclusively boxed at a given facility, the angle of the angled surface of the chute 200 and the amount of friction of the angled surface of chute 200 may be fixed to provide a controlled descent. However, in order to fit within the space-limited floorplan of different facilities, the boxing station must be capable of accommodating multiple products of different sizes, shapes, and weights, etc.

The space constraints also limit the ability to adjust the angle of a chute 200 to control product descent. The height of the upper end of a chute is fixed by the height of the three-tier conveyor system. The height of the lower end of a chute is also fixed as it must be at a comfortable height (e.g., for ergonomic reasons) for a worker to pack boxes. With limited space, the angle of the chute in most applications (e.g., the angle of the angled surface of the chute) must be very steep as the length of the chute cannot be extended. The smart chute 200, by comparison, dynamically alters the amount of friction presented to the product by the angled surface of the chute in order to decrease the speed of descent of the varying meat products.

The meat conveyor system design is hygienic to allow for cleaning and food safety and suitable for both product contact and incidental product contact.

It shall be appreciated that any or all of the foregoing features of the meat conveyor system 100 in FIGS. 1A-1B may also be present in the other embodiments disclosed herein.

FIGS. 2-7 schematically show an exemplary variable friction chute system (smart chute) 200. Smart chute 200 is structured to provide a controlled descent for a meat product along an angled surface 206 of chute 200 from an upper end 202 of angled surface 206 to a lower end 204 of angled surface 206. Providing a controlled descent for the meat product may prevent meat from piling up at landing pad 205, which could create significant back pressure and make it difficult for a worker to lift meat products from chute 200. Operation of chute 200 to provide a controlled descent of products may also prevent meat products from falling off the landing pad 205. Additionally, operation of chute 200 to provide a controlled descent of products may help avoid causing damage to plastic packaging of many products, including meat products, and can help keep bone-in products, which are at higher risk for bone punctures to the plastic packaging, from colliding and/or causing damage to the products.

With reference to FIG. 2, smart chute 200 is configured to control the descent of the meat products by having an angled surface 206 with a controllable, changeable amount of friction (e.g., a controllable change to the average amount of friction across angled surface 206) that is presented or applied to the product placed thereon. In illustrative embodiments, the angled surface 206 can include a plurality of low friction slats 203, a plurality of high friction slats 201, a landing pad 205, a shelf 207, and one or more sensors 209. In some embodiments, chute 200 may include a frame 208, having left and right portions 208, with the angled surface 206 and landing pad 205 disposed therebetween. The one or more sensors 209 may be disposed along a length of frame 208 as depicted, and may be disposed in a manner to facilitate sensing information about products positioned on angled surface 206, such as presence, position, speed, and weight information, or other information, associated with such products. FIG. 2 schematically depicts a controller 210 in operable communication with chute 200. In some embodiments, controller 210 is configured to selectively vary the amount of friction between angled surface 206 and a product positioned on angled surface 206.

In the illustrated embodiments, the plurality of low friction slats 203 and the plurality of high friction slats 201 are arranged in an alternating sequence to form a top surface (e.g., angled surface 206) along which meat products may descend. In other embodiments, a smart chute 200 may include more or fewer slats, or the low friction slats 203 and the high friction slats 201 may be arranged in a different pattern or sequence, for example, to give chute 200 and controller 210 the ability to provide and present a desired range of friction amounts to the products being slidably transported thereon. Other modifications are contemplated. For example, the relative widths of the low friction slats 203 and the high friction slats 201 could be different from what is depicted in the accompanying figures in order to generate different amounts of friction, and different ranges of variable friction, across angled surface 206.

In certain embodiments, the plurality of low friction slats 203 may be configured to remain at a fixed height (e.g., relative to the frame 208 of chute 200). The low friction slats 203 may include a top surface comprised of a material having a lower static or kinetic coefficient of friction compared to the material comprising the top surface of the plurality of high friction slats 201. For example, the low friction slats 203 may include a top surface comprised of stainless steel or UHMW (ultra high molecular weight polyethylene) plastic, to name but two examples.

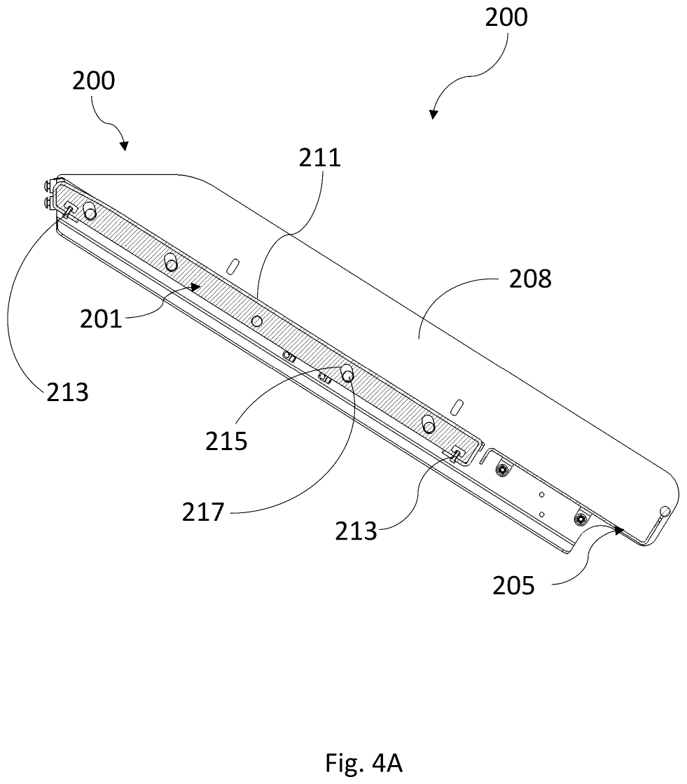

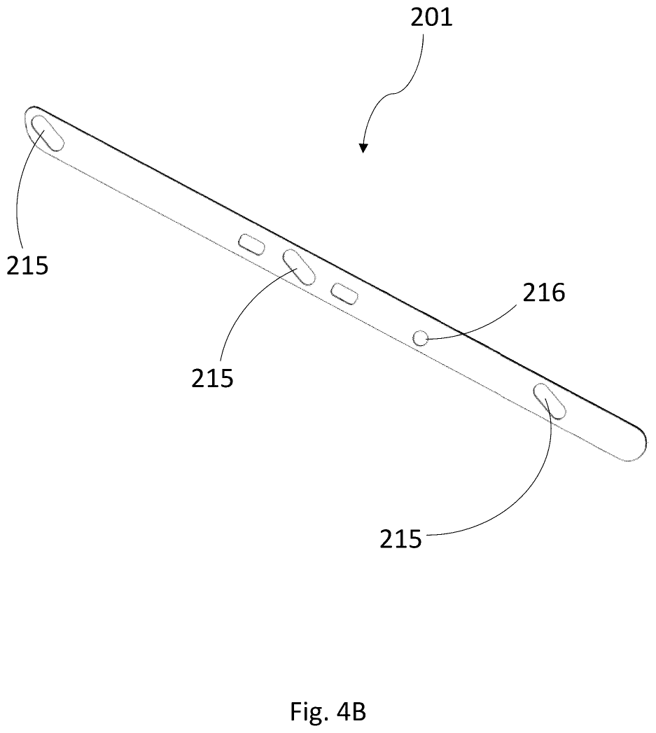

The plurality of high friction slats 201 may be configured to have a movable height (e.g., it can be moved upward and downward relative to the frame 208 of chute 200). The high friction slats 201 may include a top surface comprised of a rubber material, such as food-grade silicon, to name but one example. The plurality of high friction slats 201 may include one or more rubber material strips or cords 211 positioned along the top surface of the high friction slats 201. Such rubber strips or cords 211 can, for example, can be positioned around the perimeter of slats 201 and held in position with stainless steel grommets 213 (or other suitable fastening methods) as generally shown in the cross-sectional side view of chute 200 provided in FIG. 4A. The hardness of the rubber strips or cords 211 may be a Shore-A durometer of at least 40, meaning the rubber may have the consistency of a pencil eraser; it is typically more hard than tacky. This enables it to provide an additional amount of friction (e.g., when moved or raised in height relative to the low friction slats 203) to the angled surface presented by the chute 200 to slow the product without gripping the plastic packaging of the meat product in a way that may damage it.

It should be noted that, in some embodiments, the above-described configuration could be reversed; that is, the high friction slats 201 could be configured to have a fixed height, and the low friction slats 203 could be configured to have a movable height, and the relative heights could be varied by controller 210 to vary the overall friction of angled surface 206 as deemed appropriate for the product being slidably transported thereon. By extension, it is contemplated that both the high friction slats 201 and the low friction slats 203 could be configured to have a movable height to accomplish the same effect.

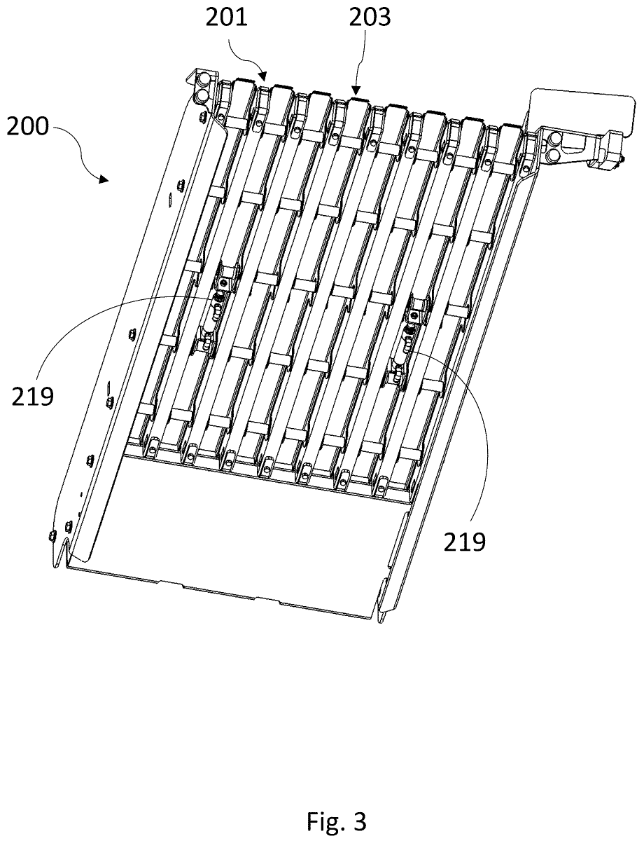

With reference to FIGS. 4A and 4B, the plurality of high friction slats 201 may include a number of slots 215 formed at a 45 degree angle relative to the surface or main axis of the high friction slats 201. Four such slots 215 are depicted in the exemplary high friction slat 201 of FIG. 4A, while three slots 215 are shown in another exemplary high friction slat 201 of FIG. 4B. The slots 215 are configured structured to translate generally longitudinal or parallel motion (e.g., parallel to the surface of the slat 201) of an actuator 219 (see FIG. 3) to a perpendicular lifting motion, as shown in FIGS. 4A and 4B, via one or more corresponding rods 217 slidably received within slots 215. A rod 217 may be received within opening 216 and operably coupled to actuator(s) 219, and may function to provide the actuation or the motive force for the generally longitudinal or parallel motion of slat 201. The distributed slots 215 positioned along the slats 201 may be structured to provide a generally uniform lifting force along a length of slats 201 when moved longitudinally, according to some embodiments.

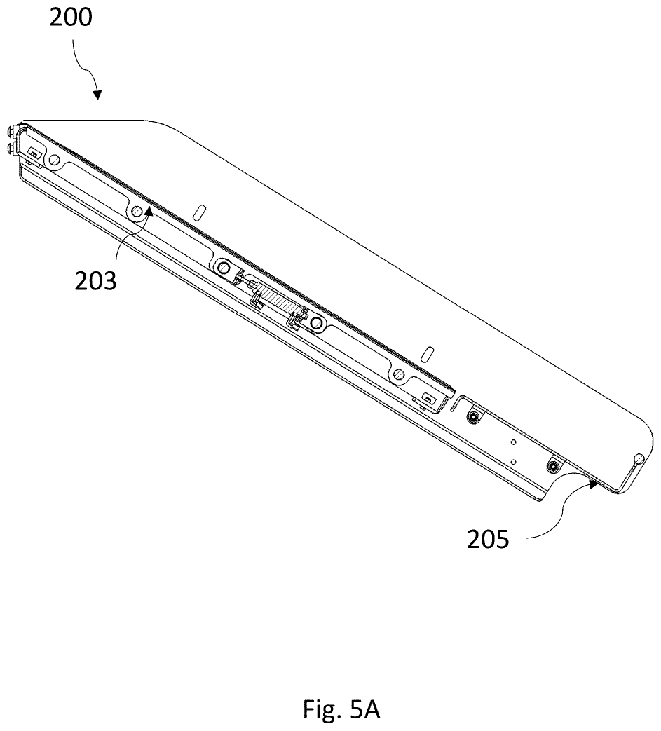

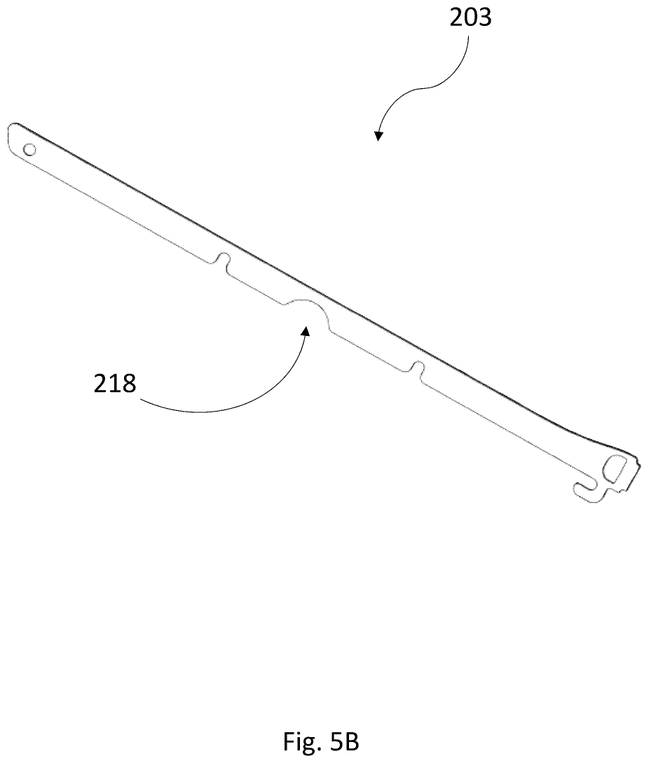

With reference to FIGS. 5A and 5B, the plurality of low friction slats 203 may be formed or arranged so as to avoid the movement caused by the lifting action described above with respect to the high friction slats 201. For example, FIG. 5B shows a recess 218 formed in a bottom portion of an exemplary low friction slat 203. Recess 218 may, for example, allow longitudinal movement of the actuation rod 217 (e.g., to thereby cause raising and/or lowering of the high friction slats 201) while not imparting any vertical force on any of the low friction slats 203, according to some embodiments.

Referring again to FIG. 2, the one or more sensors 209 may include photoelectric sensors, for example one positioned near the top of chute 200 (e.g., near the upper end 202 of angled surface 206) and one near the bottom of chute 200 (e.g., near the lower end 204 of angled surface 206) adjacent to the landing pad 205. The sensors 209 may include a computer vision system or vision sensor. The upper sensor 209 may be photoelectric (e.g., a position or presence sensor) and may be triggered when a product is pushed onto chute 200 by a powered diverter 104. The upper photoelectric sensor 209 may then provide feedback to controller 210 or to a meat conveyor control system to confirm that the routing or sortation of meat product has happened. Controller 210 also monitors the backlog, or build up, of products on chute 200, for example via the lower sensor 209, and provides the meat conveyor control system with backlog information for chute 200.

Data from the lower photoelectric sensor 209 may be used to monitor when products are lifted from landing pad 205 by a worker and placed into boxes. As items are packed, the bottom photoelectric sensor 209 is cleared, e.g., to indicate that there is room for more product to flow down the chute 200. In response, controller 210 may operate the plurality of slats 201, 203 to reduce the amount of friction presented by the angled surface 206 of chute 200, to thereby allow more product to descend from the upper portion of chute 200 to landing pad 205 for boxing.

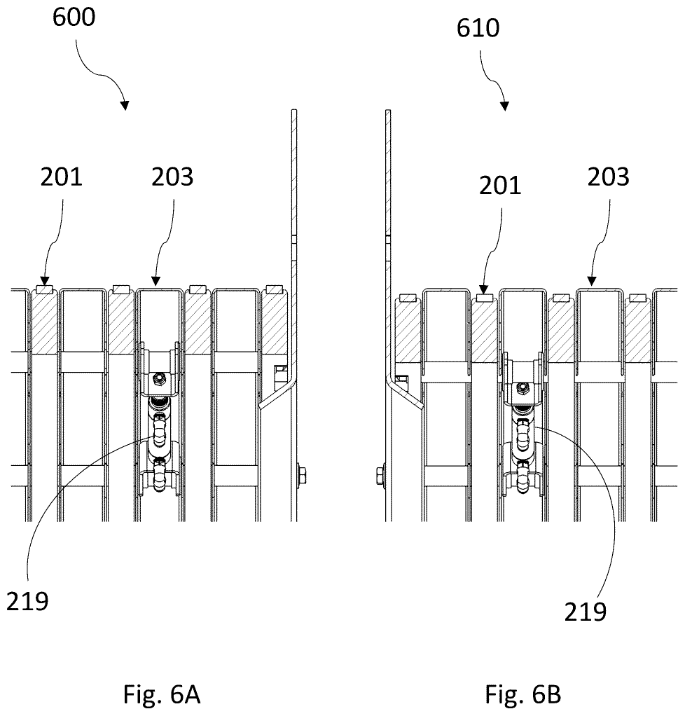

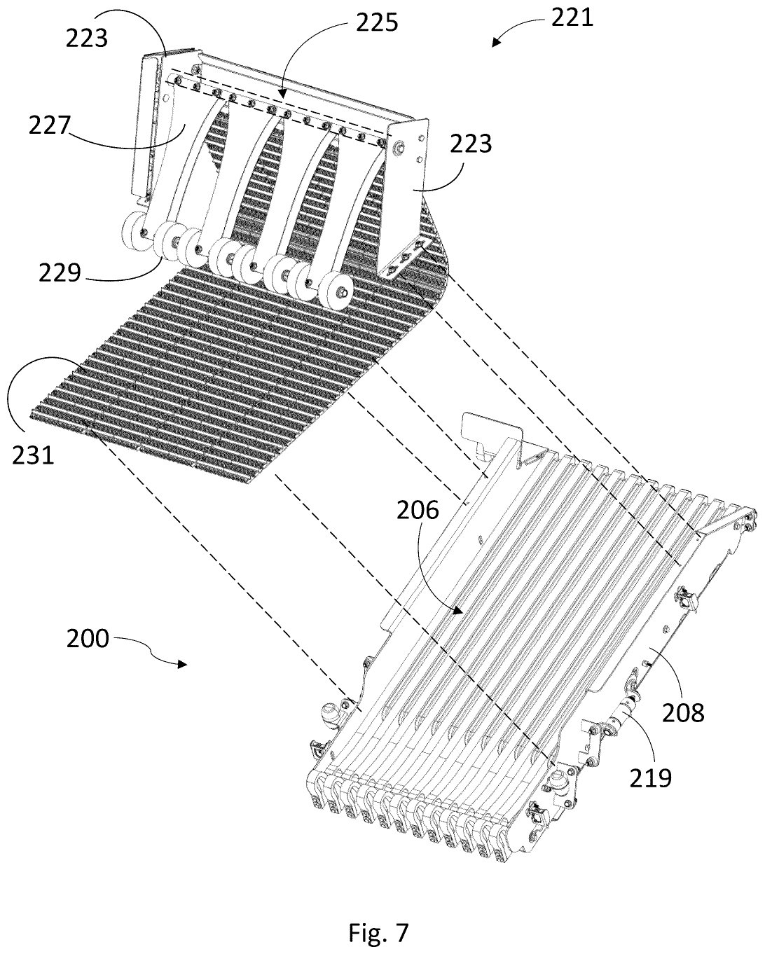

In the embodiment illustrated in FIG. 3, two actuators 219 are shown positioned below the slats 201 and 203. However, in some embodiments, actuators 219 may alternatively be positioned on an outside surface of one or both frames 208, for example as shown in FIG. 7, or any other suitable location. The actuators 219 are configured to drive the change in height of the plurality of high friction slats 201 by causing longitudinal movement of the rods 217 within slots 215, which translates the longitudinal movement to vertical displacement of the slats 201 due to the angle of the slots 215 (see FIG. 4). Among other possible technologies, the one or more actuators 219 may include an air cylinder or an electric servo to supply the needed motive force. Other embodiments may include more or fewer actuators 219. When the actuators 219 retract, they pull the plurality of high friction slats 201 downward, below the level of the low friction slats 203, as seen in chute 610 (FIG. 6B). Controller 210 is structured to control the actuators 219 in response to sensor data from the plurality of sensors 209. In some embodiments, controller 210 is structured to control the actuators 219 in further response to data collected by other components of the meat conveyor system 100 incorporating smart chute 200. For example, the collected data may include a size of the product, a dimension of the product, a weight of the product, the presence of the product in a particular location, a speed of motion of the product, a product characteristic, etc., to name but a few examples.

As noted previously with reference to FIG. 2, an upper portion of chute 200 may have a shelf 207 next to a mounting bracket to keep meat products from sliding off the conveyor onto the floor for safety. Some embodiments may include more than one shelf 207, e.g., a shelf 207 on either side of chute 200. The bottom of chute 200 includes a landing pad 205 structured to retain meat products.

It shall be appreciated that any or all of the foregoing features of smart chute 200 may also be present in the other smart chutes disclosed herein.

With reference to FIGS. 6A and 6B, there is illustrated an exemplary smart chute in a high friction mode 600 (FIG. 6A) and an exemplary chute in a low friction mode 610 (FIG. 6B). In the high friction mode 600, the static friction between the meat product and the high friction slats 201 may be enough to keep products at rest from sliding further down the angled surface 206. When the actuator 219 extends, the high friction slats 201 rise from their lower position to sit slightly above the low friction slats 203 as seen in chute 600 of FIG. 6A. The height differential between the high friction slats 201 and the low friction slats 203 may be on the order of several millimeters, or may be as much as ¼ inch to a ½ inch or more. The high friction slats 201 being raised above the height of the low friction slats 203 may cause an increase in the average amount of friction presented across angled surface 206, and accordingly, an increase in the amount of friction applied to the product on chute 200, which can slow and/or possibly stop the descent of the product on chute 200.

In low friction mode 610 (FIG. 6B), meat products positioned on angled surface 206 of chute 200 may either begin to descend from rest or increase the rate of descent compared to the high friction mode 600 of FIG. 6A. The meat product may be able to slide freely (e.g., it may be slidably transported) along the low friction slats 203 (e.g., slats 203 having a stainless steel slidable upper surface, for example) toward the lower end 204 of angled surface 206 when in the low friction mode 610.

It should be noted that the relative heights of the low friction and high friction slats 203 and 201 may be varied in a manner to effectuate variable braking at the angled surface 206. The speed at which the relative heights of the low friction and high friction slats are varied may be another aspect of variable braking, according to some embodiments. For example, in normal operating conditions, there may be two primary modes as described previously above: a low friction mode 610 and a high friction mode 600, corresponding to the slats 201 and 203 being positioned at predetermined height differentials. However, in an embodiment that employs variable braking, the amount of friction presented by angled surface 206 may be variable across a range of frictional amounts as the relative heights of the slats 201 and 203 are varied by the actuators 219 moving between the low friction and high friction modes 610, 600 of operation.

In some embodiments, the actuator(s) 219 may be configured to operate in a particular type of variable braking referred to as a “pulsed mode,” which may involve moving the high friction slats 201 up and down rapidly (relative to the low friction slats 203) to slow the descent of the product moving down the chute 200 (analogous to pumping the brakes in a car). This flexibility to vary the amount of friction presented by the chute 200 allows for dynamic control of the descent of the product. For lightweight products, no braking may be required and the high friction slats 201 may remain in the lowered position (e.g., in low friction mode 610) with the actuator 219 retracted, for example. For heavy products, the high friction slats 201 may remain in their upper position (e.g., in high friction mode 600) so that the product experiences more friction than in the low friction mode 610. In other cases, the high friction slats 201 may be pumped or raised and lowered to vary the friction experienced by the product as it slides down the chute 200.

As noted previously above, some meat products may have a rounded shape that makes them susceptible to rolling during processing and packaging. For example, a rounded product, moved off the conveyor 102 by the powered diverter 104, might begin to roll down the angled surface 206 of the smart chute 200. FIG. 7 is an exploded perspective view showing an embodiment of a smart chute 200 having a roll prevention feature 221 configured to stop a product from rolling down the angled surface 206 of chute 200. For example, portions of a roll prevention feature 221 may be generally positioned near an upper end of angled surface 206. The dashed lines in FIG. 7 illustrate how the roll prevention feature 221 may be positioned on and coupled to chute 200. In some embodiments, roll prevention feature 221 may include a rod 225 (partially obscured in FIG. 7, represented by dashed lines) extending across a width of the smart chute 200. Rod 225 may be suspended above angled surface 206 by one or more side brackets 223, which may extend upwards from frame 208 of chute 200, substantially as shown in FIG. 7. Roll prevention feature 221 may also include belting 231 movably suspended from rod 225 (or from portions of side brackets 223) and extending down toward angled surface 206. Belting 231 may be a weighted flap or sheet of flexible material configured to apply some amount of weight or pressure from above the surface of angled surface 206 in order to help prevent rolling of products along angled surface 206. Belting 231 may provide a means by which a rolling product may have its momentum absorbed by a vertical portion of belting 231 extending downward from rod 225. The weight of the belting 231 may apply pressure to keep the product on the chute 200 and limit rolling of rounded products. In some embodiments, roll prevention feature 221 may further include one or more arms 227 extending downwardly from rod 225 to provide additional means for stopping a rolling product. Arms 227 may be configured to pivot about an axis of rod 225 as a rolling product comes into contact with belting 231; the one or more arms 227 may additionally be provided with a variable spring force to aid in the ability to prevent rolling of product. Further, arms 227 may include one or more rollers 229 rotatably disposed at a lower portion of arms 227 to further assist in stopping a product from rolling down angled surface 206 of chute 200. In some embodiments, one or more of the arms 227 may be operably coupled to an actuator or actuators configured to move the arms 227 (e.g., rotate, raise, lower, etc.) as appropriate or as needed, for example, to add to or vary the amount of stopping force applied by the arms 227 to the rolling product. The actuator in such an embodiment may be coupled to and/or controlled by the controller 210, which may actuate the actuator to move the arms 227 in response to some information about the product received by the controller 210. For example, the controller 210 may receive an information signal from the one or more sensors 209 indicating that the product is rolling (e.g., based on the speed of motion of the product exceeding a specified speed threshold, for example), and in response, the controller 210 may actuate the arms 227 (via the associated actuators) to rotate or move up or down in a manner that applies an additional stopping force to the rolling product.

It should be noted that various embodiments may apply to a wide variety of meat products. Among others, those meat products may derive from a number of organic sources, such as cows, pigs, poultry (e.g., turkey, chicken), deer, fish, etc.

According to certain embodiments, the various implementations herein can be used in combination with and/or can be incorporated into various product processing and packing systems, including the various systems that are disclosed in further detail in U.S. patent application Ser. No. 18/449,537, entitled “Product Classification, Sorting, and Packing Systems and Methods,” which was filed on Aug. 14, 2023 and is hereby incorporated herein by reference in its entirety.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system, such as the controller 210. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of various embodiments.

What is claimed is:

1. A product distribution system comprising:
a chute for directing a product, the chute comprising an angled surface configured to:
receive the product at an upper end of the angled surface, and
slidably transport the product to a lower end of the angled surface,
the angled surface configured to present a variable amount of friction between the angled surface and the product; and
a controller operatively coupled with the chute, the controller being configured to selectively vary the amount of friction between the angled surface and the product.

2. The product distribution system of claim 1 wherein the controller is configured to vary the amount of friction between the angled surface and the product based on information about the product.

3. The product distribution system of claim 1 wherein the angled surface of the chute comprises a plurality of high friction portions and a plurality of low friction portions, the controller configured to vary the amount of friction between the angled surface and the product based on information about the product.

4. The product distribution system of claim 3 wherein information about the product comprises one or more of:
(a) a type of the product;
(b) a weight of the product;
(c) a speed of the product; and
(d) a spacing of the product.

5. The product distribution system of claim 3, wherein the controller is configured to control a relative height between the plurality of high friction portions and the plurality of low friction portions in response to sensor data regarding the product.

6. The product distribution system of claim 3, wherein each of the plurality of low friction portions includes a top surface comprised of stainless steel or UHMW plastic.

7. The product distribution system of claim 3, wherein each of the plurality of high friction portions comprises a top surface comprised of rubber.

8. The product distribution system of claim 5, wherein the sensor data corresponds to a presence or a speed of a meat product descending along the angled surface of the chute.

9. The product distribution system of claim 1, further comprising a landing pad disposed near the lower end of the angled surface, the landing pad structured to retain a meat product.

10. The product distribution system of claim 3, further comprising one or more actuators structured to raise and lower at least one of the plurality of low friction portions and the plurality of high friction portions.

11. The product distribution system of innovation 10, wherein the controller is configured to operate the one or more actuators in response to sensor data about the product, wherein the sensor data about the product comprises one or more of:
(a) a type of the product;
(b) a weight of the product;
(c) a speed of the product; and
(d) a spacing of the product.

12. The product distribution system of claim 10, wherein the controller is configured to operate the actuator to adjust the height of at least one of the plurality of low friction portions and the plurality of high friction portions in response to the product exceeding a speed threshold.

13. The product distribution system of claim 12, wherein the speed threshold is greater than zero.

14. The product distribution system of claim 3, wherein the controller is configured to raise and lower the plurality of high friction portions relative to the plurality of low friction portions.

15. The product distribution system of claim 14, wherein the controller is configured to raise and lower the plurality of high friction portions relative to the plurality of low friction portions over a range of height differentials between the plurality of high friction portions and the plurality of low friction portions to effectuate variable braking of the product.

16. The product distribution system of claim 15, wherein the controller is configured to raise and lower the plurality of high friction portions relative to the plurality of low friction portions in a pulsed manner to effectuate rapid braking of the product.

17. The product distribution system of claim 3, further comprising a retainer bar configured to extend across the angled surface to prevent the product from rolling down the angled surface.
